(19) United States
(12) Patent Application Publication
(10) Pub. No.: US 2012/0072427 A1
(43) Pub. Date: Mar. 22, 2012

(54) EFFECTIVE PRODUCT RECOMMENDATION USING THE REAL-TIME WEB

(75) Inventors: Barry SMYTH, Greystones (IE); Sandra GARCIA ESPARZA, Dublin (IE); Michael P. O'MAHONY, Dublin (IE)

(73) Assignee: UNIVERSITY COLLEGE DUBLIN, NATIONAL UNIVERSITY OF IRELAND, DUBLIN, Dublin (IE)

(21) Appl. No.: 13/232,378

(22) Filed: Sep. 14, 2011

Related U.S. Application Data
(60) Provisional application No. 61/383,937, filed on Sep. 17, 2010.

(51) Int. Cl. G06F 17/30

(52) U.S. Cl. 707/741; 707/E17.002; 707/E17.005

(57) ABSTRACT

A method for generating product recommendations comprises analyzing a database of messages, comprising a set of messages posted by users of a micro-blogging service to generate a user index and a product index. The user index comprises for each of a plurality of users of the system, a ranked set of terms included by the user in their posted messages. The product index comprises for each product which is to be potentially recommended, a ranked set of terms derived from messages posted by users and referencing the product. Responsive to a query identifying a user, the user index for the user is compared to the product indices to return a limited set of product identifiers corresponding to product indices most similar to the user index. The set of product identifiers are provided as recommendations to a service provider.

### FIELD OF THE INVENTION

This invention relates to methods for generating product and/or user recommendations.

### BACKGROUND

Users of micro-blogging services submit opinions, comments, and personal viewpoints typically in the form of short, typically 140-character text messages providing abbreviated and personalized commentary in real-time. Twitter is one of the most popular of these services and in 2010 had gained of the order of 100 million users generating in the region of 50 m messages known as “tweets” per day.

While Twitter provides a client for users of their service, other micro-blog service providers produce alternative dedicated clients which operate either as interfaces to the Twitter database or to proprietary databases to service users with particular interests. For example, Blippr is a service enabling users to rate movies, books and other media. Other micro-blogging services include Tumblr, Plurk and Jaiku.

These various services, use terms such as “tweets”, “blips” etc, but for the purposes of the present specification, we will use the term “messages” for the various individual posts made by users of a micro-blog service.

Typically, micro-blog messages are relatively unstructured and noisy by comparison to the data available to services which provide movie ratings, product features, etc. However, as can be seen from Twitter, vast numbers of these messages are produced every day.

It would therefore be useful to harness the real-time opinions of users, expressed through the micro-blogging with a view to providing product recommendations to such users, in particular via a micro-blogging client.

For example, micro blog services are typically monetized through advertizing revenue, with product providers buying “impressions” which comprise instances of advertisements/recommendations delivered to user clients of the micro-blog service. Users who are interested in advertized/recommended products usually click on the product impression and this typically links the user to a producer's web-site. For a given level of user feedback by “clicking through” from a micro-blog service and indeed from a user's subsequent transactions with the producer via their website, the producer can gauge the value of their advertizing campaign via any given service.

Clearly, the more effectively a service provider can deliver recommendations to users, the more valuable impressions delivered via their service can be. Indeed the more relevant recommendations are to users, the more popular a service can become and so enable a service provider to deliver more advertisement/recommendations to larger populations of users.

It is therefore an object of the present invention to provide effective product recommendation based on micro-blog data.

### SUMMARY

According to a first aspect of the present invention, there is provided a method for generating product recommendations, the method comprising:

analyzing a database of messages, comprising a set of messages posted by users of a blogging service to generate a user index and a product index, said user index comprising, for each of a plurality of users of the system, a ranked set of terms included by the user in their posted messages, and said product index comprising for each product which is to be potentially recommended, a ranked set of terms derived from messages posted by users and referencing said product;
responsive to a query identifying a user, comparing the user index for the user to said product indices for said products to return a limited set of product identifiers corresponding to product indices most similar to said user index; and
providing said set of product identifiers as recommendations to a service provider.

According to a second aspect of the present invention, there is provided a method for generating user recommendations, the method comprising:

analyzing a database of messages, comprising a set of messages posted by users of a blogging service to generate a user index and a product index, said user index comprising, for each of a plurality of users of the system, a ranked set of terms included by the user in their posted messages, and said product index comprising for each product which is to be potentially recommended, a ranked set of terms derived from messages posted by users and referencing said product;
responsive to a query identifying a product, comparing the product index for the product to said user indices for said users to return a limited set of user identifiers corresponding to user indices most similar to said product index; and
providing said set of user identifiers as recommendations to a service provider.

Preferably, said methods comprise ranking said terms in said product index in proportion to the frequency of occurrence of terms in the set of terms for a product and in inverse proportion to the frequency of occurrence of a term in the set of all product indices.

Preferably, said methods comprise ranking said terms in said user index in proportion to the frequency of occurrence of terms in the set of terms for a user and in inverse proportion to the frequency of occurrence of a term in the set of all user indices.

Preferably, said methods comprise deriving said ranked set of terms only from messages posted by users including a positive sentiment towards a product.

Preferably, said methods comprise applying natural language processing to said messages to determine said users' sentiment towards products or product features.

Alternatively or in addition, said methods comprise applying sentiment polarity analysis to said messages to determine said users' sentiment towards products or product features.

Preferably, said messages include discrete valued information indicating users' sentiment towards a product referenced in said message.

In further aspects of the present invention, there is provided a recommender arranged to implement the functionality of the above methods; and a computer program product, stored on a computer readable medium, which when executed on a computer device is arranged to perform the steps of the above methods.

### BRIEF DESCRIPTION OF THE DRAWINGS

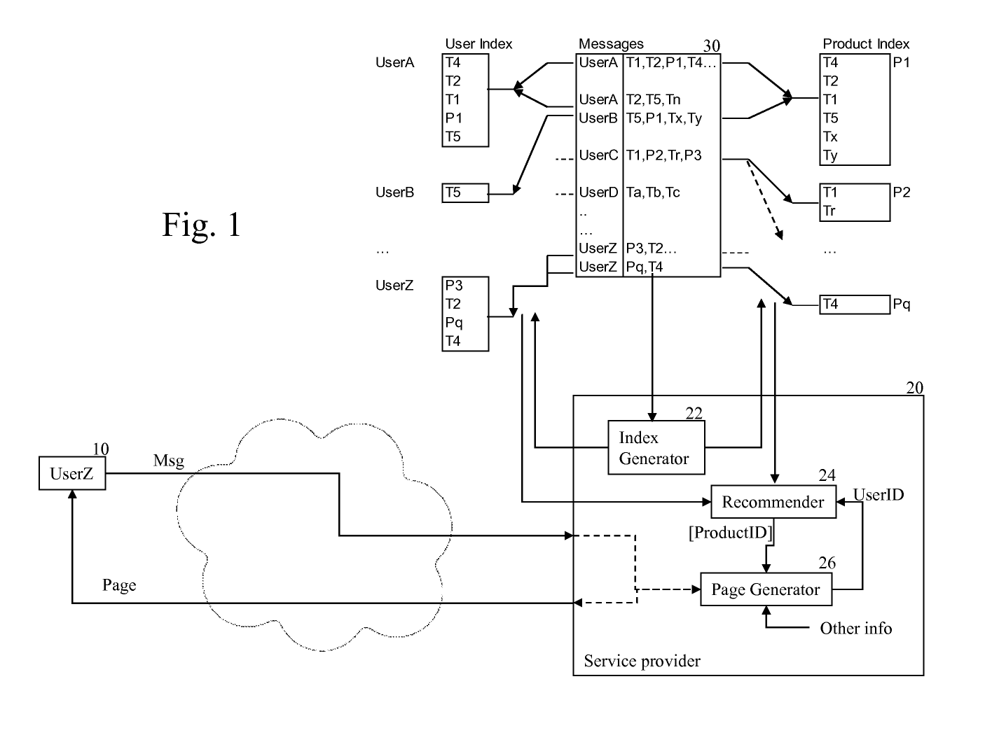

An embodiment of the invention will now be described by way of example with reference to the accompanying drawings, in which FIG. 1 is a schematic view of a system including a product recommendation system according to a preferred embodiment of the present invention.

### DESCRIPTION OF THE PREFERRED EMBODIMENT

According to a preferred embodiment of the present invention, a message base 30 comprising user-generated content relating to products and services and provided through a micro-blogging service client 10 is used as a basis for a service provider 20 to generate product recommendations which are included in page information returned to users of the service.

Typically, the micro-blogging service client 10 is either a dedicated stand alone client application running on any network connected device, or the client is implemented to run within an otherwise conventional web browser.

According to one embodiment, two indices, representing users and products respectively are created, and from these product recommendations are made to users.

### Product Index

As mentioned above, users A . . . Z of a micro-blog service generate messages. In general, messages can be thought of as a collection of terms T and although some of these terms may include an element of structure, for example, # Tags in Twitter, ratings in Blippr or short URLs in other micro-blogging services, for the purposes of the present embodiment, we will simply consider messages as a collection of alpha-numeric strings. Some messages include one or more terms comprising references to products P1 . . . Pq which a service provider might wish to recommend to suitable users of the service. Again, these referencing terms can comprise simple text, tagged text or URLs, while the products can be movies, books, websites or indeed any product or service.

To create the product index, an index generator 22 counts each occurrence of a non-product term T1 . . . T5,Ta,Tb,Tc,Tx,Ty in any message of the message base 30 mentioning a given product, so that each product P1 . . . Pq can be represented as a set of terms (words) contained in product referencing messages.

Certain stop words can be removed from this set of terms, for example, “the” “and” etc and in some implementations the set of terms could be abridged for example, being limited to no more than 100 terms, so characterizing a product by a finite list comprising the most frequent distinctive words employed by users referring to the product in posted messages. Nonetheless, limiting the list of words may not be necessary or desireable; or alternatively, could be performed after weighting the list of terms described below.

It is then useful to weight the terms that are associated with a given product based on how representative or informative these terms are with respect to the product in question. One technique for doing so is TFIDF (term frequency-inverse document frequency) described in: G. Salton and M. J. McGill. Introduction to Modern Information Retrieval. McGraw-Hill, Inc., New York, N.Y., USA, 1986. Other suitable techniques include the Okapi BM25 ranking function.

Briefly, using, for example, TFIDF, the weight of a term tⱼ in the set of terms for a product Pᵢ, with respect to some collection of products P, is proportional to the frequency of occurrence of tⱼ in the set of terms for Pᵢ (denoted by n_{tj,Pi}), but inversely proportional to the frequency of occurrence of tⱼ in P overall, thus giving preference to terms that help to discriminate a product Pᵢ from the other products in the collection. In mathematical terms, the function can be defined as follows:

$$TDIDF ( {P}_{i} , {t}_{j} , P ) = \frac{{n}_{{t}_{j} , {P}_{i}}}{{\sum }_{{t}_{k} ∈ Pi} {n}_{{t}_{k} , {P}_{i}}} \times log ( \frac{\vert P \vert}{\vert \{ {P}_{k} ∈ P : {t}_{j} ∈ {P}_{k} \} \vert} ) \qquad Eq 1$$

Thus, the index generator 22 creates a term-based index of products P, such that each entry Pᵢⱼ encodes the importance of term tⱼ for product Pᵢ:

Pᵢⱼ=TDIDF(Pᵢ,tⱼ,P) Eq. 2

One suitable tool for use within the index generator 22 to provide this indexing and term-weighting functionality is available from Lucene (http://lucene.apache.org/).

While the above embodiment is described as producing a single set of product indices, in alternative embodiments, groups of product indices can be produced, each relating to for example different categories of products, such as, movies, books etc.

### User Index

A similar approach to that described above is used to create the user index. Specifically, the index generator 22 associates each user Ui from the user population U with a limited number of terms tj, each weighted as follows:

$$\begin{matrix}TDIDF ( {U}_{i} , {t}_{j} , U ) = \frac{{n}_{{t}_{j} , {U}_{i}}}{{\sum }_{{t}_{k} ∈ {U}_{i}} {n}_{{t}_{k} , {U}_{i}}} \times log ( \frac{\vert U \vert}{\vert \{ {U}_{k} ∈ U : {t}_{j} ∈ {U}_{k} \} \vert} ) & Eq 3 \\ {U}_{ij} = TDIDF ( {U}_{i} , {t}_{j} , U ) & Eq 4\end{matrix}$$

In the above, two types of index for use in recommendation are described: an index of users, based on the terms in their messages, and an index of products, based on the terms in their messages.

It will be seen that by using TFIDF, there may be no need to explicitly remove non-distinctive stop words prior to this analysis as these will more than likely be the lowest weighted terms for a product/user and so should have little effect on recommendation. Nonetheless, removing (or simply not adding) stop words to product/user indices can simplify the weighting calculations. Further, removing stop words can avoid spurious matches between users/products which are based on stop words only; for example in cases where users/products have no common terms other than stop words and in such cases no recommendations should be made.

For recommendations, a recommender 24 uses target user's profile generated by the index generator 22, for example, UserZ comprising the weighted list of terms as a query against the product index to produce a ranked-list of products [ProductID] which are likely to be of interest to the user. This list of products can in turn be used by a page generator 26 which, as well as generating information for the user from other information sources, for example, from the message base 30, includes the product recommendations in pages provided to the user client for display.

As mentioned previously, these recommendations typically take the form of graphics incorporated with the pages supplied to the user and if the user clicks on a given graphic, they are linked to a product web site for further processing.

In one implementation, the recommender 24 passes the query to a search function provided by Lucene and this returns the most similar documents (products in this case) to the query document from the Product index. In order to find the most similar documents to a given query, Lucene uses a scoring formula which computes a score for each product document in the index based on the weightings of the terms in the respective indices so that the most similar products to the query document are returned to the recommender 24 to be in turn provided to the page generator 26.

It will be seen that in other implementations, the recommender 24 could be arranged to provide recommendations elsewhere than to the page generator 26 of the micro-blogging service. Thus, if a user identifier for any user of the micro-blogging service were provided by a 3^{rd} party service provider, the micro-blogging service provider could return a list of product recommendations to the 3^{rd} party service provider.

It will be seen that the above implementation is independent of the sentiment users may be expressing in their messages in relation to various products—thus every reference to a product in a message would be treated as if the user were expressing positive sentiment to the product.

In some message bases, structured content may be available and this can assist in determining sentiment. So, for example, in Blippr, users supply discrete ratings for movies, books etc. ranging from like to dislike. This means that terms used in messages containing these ratings can be associated with positive or negative product sentiment.

On the basis that recommender systems are interested in knowing which products people want rather than those they don't want, using user supplied ratings enables the index generator 22 to use terms appearing only in messages expressing (strong) positive sentiment for a product/service when building the product indices and optionally the user indices.

In further refinements of the above implementations, either as an addition or alternative to using user supplied ratings, combinations of natural language processing and/or sentiment polarity analysis are employed with a view the determining whether users including certain phrases and/or words within their messages are likely to be interested in receiving recommendations for certain products.

Thus, natural language processing or sentiment polarity analysis can be employed to determine if users are expressing positive sentiment towards a product, product features or multiple products mentioned in a message and this can be used to determine whether given messages will be employed in updating the product and/or user indices.

In alternative embodiments of the invention, based on the generated Product and User indices from a message base 30, the recommender 24 could be queried with a particular product index and return a ranked set of most similar users (and possibly their individual index documents) which could in turn be provided to third parties interested in marketing separately to such users. Such an approach would of course have to comply with data protection legislation.

Other possibilities for using the indices either alone or in conjunction with the above-described implementations include querying the product indices with a product index. This could produce a list of products similar to a given product and which might be recommended to user(s) who had indicated an interest in a given product.

Equally, querying the user indices with a given user index could return the most similar users to the given user for making recommendations to a community of users.

In the above described embodiments, the index generator is described as analyzing the message base 30 to provide the product and user indices. This can be done once, or the indices can be iteratively updated based on any number of criteria. For example, indices can be updated each time messages are posted to the service provider 20, or alternatively indices can be either updated or refreshed completely on a periodic basis. Equally, messages could be weighted according to their age, so that terms from the oldest messages in the message base 30 would receive lower weighting within the product or user indices than terms from more recent messages.

The invention is not limited to the embodiment(s) described herein but can be amended or modified without departing from the scope of the present invention.

1. A method for generating product recommendations, the method comprising:
analyzing a database of messages, comprising a set of messages posted by users of a blogging service to generate a user index and a product index, said user index comprising, for each of a plurality of users of the system, a ranked set of terms included by the user in their posted messages, and said product index comprising for each product which is to be potentially recommended, a ranked set of terms derived from messages posted by users and referencing said product;
responsive to a query identifying a user, comparing the user index for the user to said product indices for said products to return a limited set of product identifiers corresponding to product indices most similar to said user index; and
providing said set of product identifiers as recommendations to a service provider.

2. A method according to claim 1 further comprising ranking said terms in said product index in proportion to the frequency of occurrence of terms in the set of terms for a product and in inverse proportion to the frequency of occurrence of a term in the set of all product indices.

3. A method according to claim 1 further comprising ranking said terms in said user index in proportion to the frequency of occurrence of terms in the set of terms for a user and in inverse proportion to the frequency of occurrence of a term in the set of all user indices.

4. A method according to claim 1 further comprising deriving said ranked set of terms only from messages posted by users including a positive sentiment towards a product.

5. A method according to claim 4 further comprising applying natural language processing to said messages to determine said users' sentiment towards products or product features.

6. A method according to claim 4 further comprising applying sentiment polarity analysis to said messages to determine said users' sentiment towards products or product features.

7. A method according to claim 1, wherein said messages include discrete valued information indicating users' sentiment towards a product referenced in said message.

8. A method according to claim 1, wherein the service provider is either the blogging service provider; or a service provider other than the blogging service provider.

10. A recommender arranged to implement the functionality of the method of claim 1.

11. A computer program product, stored on a computer readable medium, which when executed on a computer device is arranged to perform the steps of claim 1.

12. A method for generating user recommendations, the method comprising:
analyzing a database of messages, comprising a set of messages posted by users of a blogging service to generate a user index and a product index, said user index comprising, for each of a plurality of users of the system, a ranked set of terms included by the user in their posted messages, and said product index comprising for each product which is to be potentially recommended, a ranked set of terms derived from messages posted by users and referencing said product;
responsive to a query identifying a product, comparing the product index for the product to said user indices for said users to return a limited set of user identifiers corresponding to user indices most similar to said product index; and
providing said set of user identifiers as recommendations to a service provider.

13. A recommender arranged to implement the functionality of the method of claim 12.

14. A computer program product, stored on a computer readable medium, which when executed on a computer device is arranged to perform the steps of claim 12.
